(19) United States
(12) Patent Application Publication
(10) Pub. No.: US 2022/0332959 A1
(43) Pub. Date: Oct. 20, 2022

(54) TWO-COMPONENT URETHANE FOR THE REPAIR OF WOOD AND WOOD PRODUCTS AND THE METHODS OF USING THE SAME

(71) Applicant: The Willamette Valley Company LLC, Eugene, OR (US)

(72) Inventors: J. Evan Davis, Eugene, OR (US); Nicklas Polizzi, Eugene, OR (US)

(73) Assignee: The Willamette Valley Company LLC, Eugene, OR (US)

(21) Appl. No.: 17/640,226

(22) PCT Filed: Aug. 31, 2020
(86) PCT No.: PCT/US2020/048767

§ 371 Date: Mar. 3, 2022

Related U.S. Application Data
(60) Provisional application No. 62/896,863, filed on Sep. 6, 2019.

(51) Int. Cl. C09D 5/34; C09D 175/14

(52) U.S. Cl. CPC C09D 5/34; C09D 175/14

(57) ABSTRACT

The present invention provides an improved product and method of applying a product to remedy any deficiencies of wood and wood products while maintaining the quality of current processing and increasing efficiency. In one aspect of the present invention, a method of repairing wood or wood products comprises analyzing a wood or wood product for a defect, the wood or wood product having a surface; identifying the defect in the wood or wood product; identifying a location of the defect in said wood or wood product; preparing for repair the surface of the wood or wood product in the location of said defect; applying a two-component urethane to the surface of said wood or wood product in the location of the defect, said two-component urethane comprising a polyol mixture and an isocyanate; and, curing the two-component urethane for a period of time.

### BACKGROUND

### 1. Technical Field

The present invention relates to methods of repairing wood, particularly methods of repairing defects in wood and wood products used in furniture by applying a two-component urethane to the surface of the wood.

### 2. Background Information

Wood and wood products, including plywood and other engineered wood, have been used to manufacture household products and building materials, including cabinets, doors, windows, furniture, and other items. Wood and wood products may exhibit defects which adversely affect the quality of the material and which may make it unsuitable for intended uses and may be either growth related or process related.

An example of a defect that may make wood or wood products unsuitable for an intended use are knots and/or knot holes. Knots may make it difficult to prepare a smooth finish on the surface of a board, may bleed pitch, and are frequently not a secure and solid feature of the wood element, providing an insecure and unsuitable substrate. Another problem for the production of wood and wood products are pitch defects. Pitch defects develop through the accumulation of resin in excessive amounts in localized regions. These defects include pitch, pitch streaks, and pitch pockets. Resin or pitch is a significant constituent of both softwoods, including pine, such as southern pine, loblolly pine, red pine, slash pine, spruce, fir and other conifers and hardwoods, such as eucalyptus, betula and populus. Other forms of localized defects can also be present in wood and wood products such as decayed areas, boughs, impact damage or excavations made by birds or insects.

One method to repair defects in wood or wood products is by using wood plugs. The wood plugs may be pre-measured and may have a variety of regular and irregular shapes including, but not limited to, round, oblong, diamond, square, and triangular. When defects are repaired with a wood plug, the wood or wood product is first routed and cut with a standardized tool. This step is a necessary aspect of the repair process due to the standardized geometry of the wood plugs. Following the cutting step, the defect is next blown clear with compressed air. A wood adhesive is placed into the area of repair and one of the standardized, pre-shaped wood plugs is positioned into the area of repair, either by hand or with a hammer. After the wood plug is positioned into place, the wood or wood product returns back to the customary manufacturing flow, where it may be sanded, routed, or planed; lacquered; and finished. While the current processes may provide high quality repair, the processes are quite labor intensive and may create inefficiencies and waste when the defects in the wood and wood products are outside of the pre-measured sizes of the wood plugs.

When plywood and other engineered products are used to produce furniture products, it is critical that the repaired wood meet the same standards and has similar properties as unrepaired wood furniture. These features include the following: hardness; minimal bubble formation during repair; stability in varying temperature and humidity; ability to cure or set quickly; and the ability to be painted, machined, sanded, milled, and bear loads like wood.

### SUMMARY OF THE INVENTION

Thus, the present invention provides an improved product and method of applying a product to remedy any deficiencies of wood and wood products while maintaining the quality of current processing and increasing efficiency. In particular, the present invention relates to two-component urethane and a method of repairing wood applying a two-component polyurethane. The repaired wood or wood products may be used for further uses such as furniture production or after constructing furniture using at least one piece of wood or wood products.

In one aspect of the present invention, a method of repairing wood or wood products comprises analyzing a wood or wood product for a defect, the wood or wood product having a surface; identifying the defect in the wood or wood product; identifying a location of the defect in said wood or wood product; preparing for repair the surface of the wood or wood product in the location of said defect; applying a two-component urethane to the surface of said wood or wood product in the location of the defect, said two-component urethane comprising a polyol mixture and an isocyanate; and, curing the two-component urethane for a period of time. In one embodiment, polyol mixture comprises one or more oils. In another embodiment, the polyol mixture comprises a blend of one or more oils and at least one of a filler, a catalyst, or other additive material. In yet another embodiment, the method further includes removing said defect from said wood or wood product prior to the applying step.

In another aspect of the invention, a method of repairing wood or wood products, comprises analyzing a wood or wood product for a defect, said wood or wood product having a surface; identifying said defect in said wood or wood product; identifying a location of said defect in said wood or wood product; preparing for repair said surface of said wood or wood product in the location of the defect; applying a two-component urethane to said surface of said wood or wood product in the location of the defect, the two-component urethane comprising a polyol mixture and an isocyanate; curing said two-component urethane for a period of time; and, processing said wood or wood product for furniture manufacturing after the wood or wood product has cured for a period of time. In one embodiment, the isocyanate is a polymeric methyl diphenyl diisocyanate. In another embodiment, the polyol mixture and the isocyanate are applied in a ratio by volume ranging from 1:1 to 6:1.

In yet another aspect of the invention, a method of building an article of furniture comprises analyzing at least one piece of wood or wood product having a surface for a defect; identifying the defect in said at least one piece of wood or wood product; identifying a location of said defect in the at least one piece of wood or wood product; preparing for repair the surface of the at least one piece of wood or wood product in the location of the defect; applying a two-component urethane to the surface of the at least one piece of wood or wood product of the article of furniture in the location of said defect, the two-component urethane comprising a polyol mixture and an isocyanate; curing the two-component urethane for a period of time; and building an article of furniture using said at least one piece of wood or wood product after the two-component urethane has cured for a period of time.

### BRIEF DESCRIPTION OF THE DRAWINGS

Hereinafter, the invention will be explained in further detail, by way of example only, of the accompanying figures, in which:

FIG. 1 is a flow chart of a repair process line system for use with the present invention.

### DETAILED DESCRIPTION

The invention is described with reference to the drawings in which like elements are referred to by like numerals. The relationship and functioning of the various elements of this invention are better understood by the following detailed description. However, the embodiments of this invention are not limited to the embodiments illustrated in the drawings. It should be understood that the drawings are not to scale, and in certain instances details have been omitted which are not necessary for an understanding of the present invention, such as conventional fabrication and assembly.

As used in the specification, the term “diol” should be understood to mean a chemical compound containing two hydroxyl groups, such as a di-functional alcohol.

The term “triol” should be understood to mean a chemical compound containing three hydroxyl groups, such as a tri-functional alcohol.

The term “quadrol” should be understood to mean a chemical compound containing four hydroxyl groups, such as a tetra-functional alcohol.

The term “wood” should understood to refer to pieces of timber, lumber, logs, flitches, cants, beams, posts, studs, boards, veneer, and/or any other pieces of wood smaller than the whole tree and larger than sawdust.

The term “wood product” should be understood to cover engineered wood products made from pieces of wood that are secured together using adhesives and/or binders to produce a composite wood product. Different types of engineered wood products can be manufactured from different wood-based feedstocks, such as strands, fibers, chips or thin layers (plies). Common engineered wood products include particle board, fiberboard, and plywood, e.g., medium-density fiberboard (MDF). Engineered wood products can vary in their structural and/or non-structural properties, and find a variety of uses such as in furniture and construction.

The two-component urethane of the present invention provides performance characteristics that are essential to the satisfactory repair of wood and wood products, such as plywood and other engineering products; particularly, satisfactory repair of wood and wood products used for furniture. As defined by this application, the term “satisfactory repair” includes at least the following characteristics: hardness similar to pine or other similar wood materials; a tactile quality similar to wood, an application free of bubbles or substantially free of bubbles, a rate of polymerization that allows for the two-component urethane to be tack-free in two minutes or less; a material that is affordable and minimizes the cost of manufacture, and compliance with chemical hygiene standards. In addition, the repaired wood or wood products must also be sandable, paintable, toolable, and generally useable in all of the same ways as unrepaired pine used to produce furniture.

The two-component urethane of the present invention and methods of using such provides a “liquid repair” approach and comprises a polyol mixture and an isocyanate component. The isocyanate containing compound should have at least one isocyanate functional group. The functional group may be an aliphatic isocyanate, a cycloaliphatic isocyanate, an aryl isocyanate, an aromatic cyanate, or a combination thereof. The functional group may be 1,6-hexamethylene diisocyanate, 1,4-butylene diisocyanate, furfurylidene diisocyanate, 2,4-toluene diisocyanate, 2,6-toluene diisocyanate, 2,4′-diphenylethane, diisocyanate, 4,4′-diphenylmethane diisocyanate, 4,4′-diphenylpropane diisocyanate, 4,4′-diphenyl-3,3′-dimethyl methane diisocyanate, 1,5-naphthalene diisocyanate, 1-methyl-2,4-diisocyanate-5-chlorobenzene, 2,4-diisocyanate-s-triazine, 1-methyl-2,4-diisocyanato cyclohexane, p-phenylene diisocyanate, dianisidine diisocyanate, bitolylene diisocyanate, 1,4-xylylene diisocyanate, 1,3-xylylene diisocyanate, bis-(4-isocyanatophenyl)methane, bis-(3-methyl-4-isocyanatophenyl)methane, polymethylene polyphenyl polyisocyanates or a combination thereof. In a particular embodiment, the isocyanate component may be a polymeric methyl diphenyl diisocyanate. The aforementioned list of isocyanate functional groups is representative of the isocyanate functional groups that may be used. However, the isocyanate functional groups suitable for use are not particularly restricted. U.S. Pat. No. 5,422,385, hereby incorporated by reference in its entirety, provides additional isocyanates that may be used.

The polyol mixture may be a blend of one or more oils, and at least one of fillers, catalysts, or other additive materials. As provided in the present application, oils may include chemical compounds including diols, triols, quadrols, and mixtures thereof. Examples of suitable diols, triols, and quadrols include, but are not limited to, polyethylene ether diols and triols; polypropylene ether diols and triols, saturated polyester diols and triols, unsaturated polyester diols and triols, polycaprolactone diols and triols, polytetrahydrofuran diols, and diamine initiated quadrols. Other oils suitable for use with this invention include hydroxy functionalized vegetable oils and castor oil. Examples of hydroxy functionalized vegetable oils include olive oil, sunflower oil, linseed oil, tall oil, soybean oil, colza oil, fish oil, cottonseed oil, palm oil, palm kernel oil, coconut oil, canola oil, flaxseed oil, high oleic canola oil, safflower oil or every other known saturated and unsaturated vegetable oil.

In some embodiments, the polyol mixture comprises one or more oils in addition to fillers, catalysts, and other materials. In some embodiments, the polyol mixture comprises at least six oils in addition to fillers, catalysts, and other materials. In some embodiments, the polyol mixture comprises at least six oils in addition to fillers, catalysts, and other materials. In other embodiments, the polyol mixture may comprise a blend of at most six oils in addition to fillers, catalysts, and other materials. In a particular embodiment, the polyol mixture comprises exactly six oils in addition to fillers, catalysts, and other materials.

A filler may also be included as a component in the polyol mixture. Exemplary fillers include glass, sand, rock, rubber crumb, architectural stone, low density fillers such as polystyrene beads (expanded or unexpanded) or expanded glass beads, or combinations thereof. In some embodiments, the suitable fillers may include ground or milled recycled glass, ground or milled calcium carbonate, ground or milled silicate, ground or milled mica, ground or milled diatomaceous earth, engineered hollow glass spheres, hollow synthetic plastic spheres, reclaimed ceramic particles, and engineered ceramic spheres. The filler materials may be at least 5 micron. In particular embodiments, the filler materials may be at most 500 microns. In additional embodiments, the filler materials may range from 5 microns to 500 microns. The glass may be of any type and may be clear, tinted, and/or colored.

Other additive materials that may be included in the polyol mixture include air release additives, filler wetting aides, catalysts, color pigments, and rheology modifiers. Exemplary materials that may be included in the polyol mixture include, but not limited to, fumed silica, thixotropes, controlled flocculation additives, air release additives (e.g. silicone and solvents), defoaming additives, non-tin organometallic catalysts, non-mercury organometallic catalysts, mineral wetting/dispersing agents, inorganic pigments, and moisture scavenging additives.

Embodiments of the invention may be used to repair wood or wood products in different stages of processing. In some embodiments, the repair of wood or wood products occurs prior to the processing the wood for further uses such as furniture production or after constructing furniture using at least one piece of wood or wood products. For example, the two-component urethane may repair defects in furniture constructed from at least one piece of previously repaired wood or wood products. Embodiments of the present invention may also be used to repair defects in furniture constructed from unrepaired wood or wood products. The term “defects” should be understood to include knots, pitch, pitch streaks, and pitch pockets, as well as other forms of localized defects in wood and wood products including decayed areas, boughs, impact damage or excavations made by birds or insects.

Repairing wood or wood products according the present invention may be manual, automated, or may comprise a combination of a manual and automated process. In one embodiment, automation may identify any defects in the wood or wood products, remove the defect, if necessary, and apply the two-component urethane to the surface of the wood or wood products. In another embodiment, automation may identify any defects in the wood or wood products, and a manual process may remove the defect, if necessary, and apply the two-component urethane to the surface of the wood or wood products. In yet another embodiment, an automated process may identify any defects in the wood or wood products and remove the defect, if necessary, and a manual process may apply the two-component urethane to the surface of the wood or wood products. In a different embodiment, a manual process may identify any defects in the wood or wood products, remove the defect, if necessary, and apply the two-component urethane to the surface of the wood or wood products. In still another embodiment, a manual process may identify any defects in the wood or wood products, remove the defect, if necessary, and automation may apply the two-component urethane to the surface of the wood or wood products.

The two-component urethane and the method of applying the two-component urethane to repair wood or wood products provides a number of advantages over previous methods of repair. Specifically, the two-component urethane and the methods of applying the two-component urethane to repair wood or wood products, in particular, wood or wood products used for furniture, provide at least the following advantages: improved efficiency over the manual process of using pre-measured wood plugs; an increase in the rate of repair; an increase in the types of defects that may be repaired, including pitch defects; the ability to fill naturally occurring defects, which create a more natural, or wood-like, appearance in the area of repair, an increase the percentage of green wood that may be converted into finished furniture; and avoiding waste of wood or wood products by increasing the amount of wood that is capable of being repaired, and reducing the need to remove wood from the area of defect in order to fit the pre-determined wood plugs.

In one aspect of the present invention, a wood or wood product is analyzed to identify any defects in the wood or wood product. After identifying a defect and the location of the defect, the surface of the wood or wood product is prepared for repair and a two-component urethane is applied to the surface of the wood product in the location of the defect. The two-component urethane applied to the surface of the wood or wood product in the location of the defect comprises a polyol mixture and a isocyanate. In one embodiment, the polyol mixture and the isocyanate are applied jointly or simultaneously to the area of the defect.

The polyol mixture and the isocyanate may be stored in drums or international bulk container (“IBC”) totes near the area of application. In some aspects, a mechanical system of meters and pumps may be used to deliver the polyol mixture and the isocyanate to the repair area of the wood or wood product in order to assure the pre-determined ratio is maintained accurately through the process. If the defect is one that needs to be removed from the surface of the wood or the wood product, the user may remove the defect prior to application of the two-component urethane. This removal of the defect may be by conventional means, such as cutting, using a sand blaster, air knife, or pneumatic chisel, and the removal may be performed manually or through an automated process. After the two-component urethane is applied to the surface of the wood or wood product in the area of the defect, the two-component urethane is allowed to polymerize and the repair is completed. Any step of the repair process may be manual, automated, or may comprise a combination of a manual and automated process.

Repaired wood or wood products may be further processed for a number of different uses including, but not limited to, furniture and building materials. In a preferred embodiment, repaired wood or wood products are processed for manufacturing furniture and furniture is manufactured from at least one piece of wood or wood products. In another aspect of the present invention, a method of building an article of furniture is provided. According to the method, at least one piece of a wood or wood product is analyzed to identify any defects. After identifying a defect and the location of the defect, the surface of the wood or wood product is prepared for repair and a two-component urethane is applied to the surface of the wood or wood product.

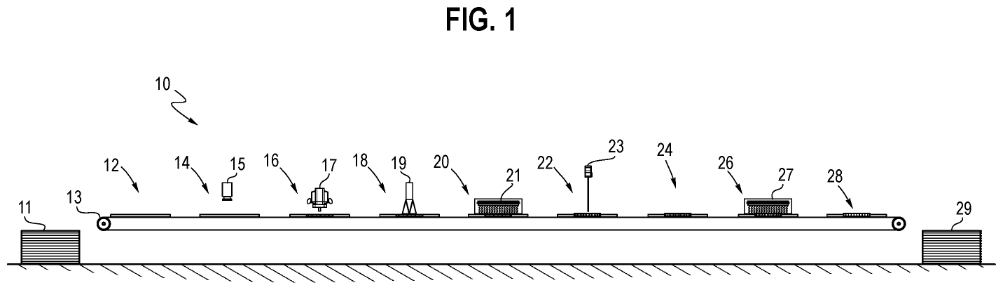

FIG. 1 provides a flow diagram of an embodiment of a repair process line system 10 for use with the present invention. As shown in flow chart 10, the repair process line system 10 may include multiple processing sections. In this embodiment, the process of repair includes an infeed section 12, a vision section 14, a routing section 16, a defect cleaning section 18, a wood conditioning section 20, a fill section 22, a curing section 24, a post conditioning section 26, and a stacker section 28. In some embodiments, sections may be added or removed depending on the nature of the repair being made. In a particular embodiment, the vision section 14, the routing section 16, the defect cleaning section 18, the wood conditioning section 20, and the post conditioning section 26 are optional.

In the present embodiment, the infeed section 12 is a translocation of wood or wood product 11 to the beginning of the repair process line system 10 on to the application line 13. The application line may comprise a conveyer system. The infeed section 12, after receiving the wood or wood products 11, transport the wood or wood products 11 to the vision section 14 of the repair process line system 10. In the vision section 14, the wood or wood products 11 may be evaluated to identify any necessary repairs. If a defect is identified during the vision section 14, then the defects may be mapped in order to allow for the wood or wood product 11 to be repaired. The vision section 14 may include sensors, lasers, cameras, and/or detectors 15 in order to signal and map defects in the wood or wood products 11. In other aspects, the sensors and detectors 15 of the vision section 14 may also signal to stop production or adjust grade rules of the wood or wood product 11. During the vision section 14, the defect in the wood or wood product 11 may be mapped or measurements of the defect's size and volume may take place. In embodiments where the repair process line system 10 is manual, the vision section 14 may not be included and the identification of defects in the wood or wood product 11 may be performed with either at infeed section 12 or the routing section 16 in order to identify any defects.

The repair process line system 10 further includes a routing section 16. The routing section 16 may include one or more processing devices 17 for the purposes of preparing, cutting, drilling, and/or routing of any identified defects in the wood or wood products 11. These features of the routing section 16 may be performed using manual tools, automated tools, or a combination of both. The routing section 16 may be an optional section of the repair process line system 10 depending on the repair surface requirements and type of defect in the wood or wood product 11. Removal of routing debris may take place during the defect cleaning section 18. A debris removal apparatus 19, including but not limited to, a pneumatic knife or a vacuum, possibly with the aid of a brush mechanism, may be used in order to remove the remaining debris from the wood or wood product 11 while the wood or wood product 11 is present in the defect cleaning section 18.

In the wood conditioning section 20 of the repair process line system 10, the wood or wood product 11 is preheated by a heating apparatus 21. The process of preheating the wood or wood product 11 assists with improving the acceptance of the two-component urethane of the present invention. At a minimum, the wood conditioning section 20 involves elevating the surface temperature of the wood or wood product 11, which consequently raises the temperature of the surface of two-component polyurethane that is exposed to the heated wood or wood product 11 when it is applied to repair the defect. The temperature of the surface of the wood or wood product 11 may be at least 10° C. greater than the temperature of the two-component polyurethane at the point of application. One of skill in the art would understand that other surface preparations may also be necessary during this step depending on the wood or wood product to be prepared.

After pre-heating the wood or wood product 11 in the wood conditioning section 20, the wood or wood product 11 is transported to the fill section 22 of the repair process line system 10. During the fill step 22, a properly portioned amount of the two-component urethane is delivered to the wood or wood product to repair any defects in the wood or wood product. The fill section 22 may be completed manually, with automated tools, or through a combination of both manual tools and automated tools.

In some embodiments, the proportioning and mixing of the two-component urethane may be completed by a filling apparatus 23 comprising a mechanical metering system and a mixing apparatus. The polyol mixture and the isocyanate of the two-component urethane may be delivered in a ratio by volume by the mechanical metering system. For some embodiments, the ratio by volume applied of the polyol mixture and the isocyanate ranges from 1:1 to 6:1. In a particular embodiment, the polyol mixture and the isocyanate may be applied in a 4:1 ratio by volume. The ratio by volume may be modified in other embodiments based on the repair needed for the wood or wood product 11.

The mixing apparatus may be a static mixing apparatus or a dynamic mixing apparatus. In embodiments comprising a static mixing apparatus, the polyol mixture and the isocyanate of the two-component urethane are blended using a flow current. The polyol mixture and the isocyanate of the two-component urethane, at the desired ratios, may be placed into a tube, or mixer channel, with flow control elements, such as static mixer elements, or a mixer bore, mounted end-to-end on the inside. In embodiments comprising a dynamic mixing apparatus, the polyol mixture and the isocyanate of the two-component urethane may be fed into a mixing chamber and blended by a rotating mixer. Dispersive and distributive mixing of the two-component urethane is achieved using shear and elongation blades. While in this embodiment, the polyol mixture and the isocyanate of the two-component urethane are mixed prior to application, it is understood that the polyol mixture and the isocyanate of the two-component urethane may be applied separately or simultaneously.

The curing section 24 of the repair process line system 10 comprises the polymerization of the two-component urethane applied to the wood or wood product 11. During this step, the liquid two-component urethane applied to the wood or wood product is provided adequate time to solidify in the area of repair. The two-component urethane should be undisturbed during this step in order to allow the material to completely adhere to the wood or wood product. The rate of polymerization should be chosen such that the two-component urethane is tack-free and solidly attached to the wood or wood product once polymerization is complete. This rate of polymerization may be 3 minutes or less. In one embodiment, the rate of polymerization may be 2 minutes or less. In some embodiments, the rate of polymerization may be 1.5 minutes or less. In additional embodiments, the rate of polymerization may be 1 minute or less. In still additional embodiments, the rate of polymerization may be 30 seconds or less. The rate of polymerization may also be in the range of 30 seconds to 2 minutes.

The post conditioning section 26 of the repair process line system 10 follows the curing section 24. The post conditioning section includes a heating apparatus 27. During the post conditioning section 26, the wood or wood product 11 and any repaired defects are heated to condition the wood or wood product 11 and to accelerate the polymerization of the two-component urethane. The temperature applied during the post conditioning section 26 may range from ambient to less than 65° C. Prior to heating the wood or wood product, the repaired aspect of the wood or wood product should be set, or in a solid state. The amount of time and the intensity of the heat applied to the wood or wood product may depend on the shape and the dimension of the repaired defects, as well as on the species of wood or wood product and its ability handle high temperatures. The duration is dependent on how much post curing is required in specific application/line setup. In some embodiments, the post-conditioning section 26 may overlap with the curing section 24. In these embodiments, it may be useful to remove any excess tackiness present following curing of the two component urethane in the curing section 24.

The stacker section 28 of the repair process line system 10 includes removal of the repaired wood product 29 from the application transportation of the repaired wood or wood product 29 from the application line. The repaired wood or wood product 29 may be transported for further processing including, but not limited to, sanding, calibration, coating, lacquering, or other post-processing. At the completion of post processing, the repaired wood or wood product 18 may be used to construct and build an article of furniture. While this process was described for repairing wood or wood products prior to being processed for the construction of items such as furniture, this embodiment of the present invention may also be used to repair defects in furniture constructed from unrepaired wood or wood products.

Throughout this specification various indications have been given as to preferred and alternative examples and aspects of the invention. However, the foregoing detailed description is to be regarded as illustrative rather than limiting and the invention is not limited to any one of the provided aspects. It should be understood that it is the appended claims, including all equivalents, that are intended to define the spirit and scope of this invention.

1. A method of repairing wood or wood products, comprising:
analyzing a wood or wood product for a defect, the wood or wood product having a surface;
identifying said defect in said wood or wood product;
identifying a location of said defect in said wood or wood product;
preparing for repair said surface of said wood or wood product in the location of said defect;
applying a two-component urethane to the surface of said wood or wood product in the location of the defect, said two-component urethane comprising a polyol mixture and an isocyanate; and,
curing the two-component urethane for a period of time.

2. The method of claim 1, wherein said polyol mixture comprises one or more oils.

3. The method of claim 2, wherein said polyol mixture comprises at least six oils.

4. The method of claim 2, wherein said polyol mixture comprises at most six oils.

5. The method of claim 1, wherein the polyol mixture comprises a blend of one or more oils and at least one of a filler, air release additive, filler wetting aide, catalyst, color pigment, or rheology modifier.

6. The method of claim 1, further comprising removing said defect from said wood or wood product prior to the applying step.

7. The method of claim 6, wherein the removal of said defect is automated.

8. The method of claim 6, wherein the removal of said defect is manual.

9. The method of claim 1, wherein said isocyanate is a polymeric methyl diphenyl diisocyanate.

10. The method of claim 1, wherein said polyol mixture and said isocyanate are applied in a ratio by volume ranging from 1:1 to 6:1.

11. The method of claim 1, further comprising processing said wood or wood product for manufacturing furniture.

12. The method of claim 1, wherein further comprising measuring the size and volume of the defect following identifying the location of said defect in said wood or wood product.

13. A method of repairing wood or wood products, comprising:
analyzing a wood or wood product for a defect, said wood or wood product having a surface;
identifying said defect in said wood or wood product;
identifying a location of said defect in said wood or wood product;
preparing for repair said surface of said wood or wood product in the location of the defect;
applying a two-component urethane to said surface of said wood or wood product in the location of the defect, the two-component urethane comprising a polyol mixture and an isocyanate;
curing said two-component urethane for a period of time; and,
processing said wood or wood product for furniture manufacturing after the wood or wood product has cured for a period of time.

14. The method of claim 13, wherein the polyol mixture comprises one or more oils.

15. The method of claim 14, wherein the polyol mixture comprises at least six oils.

16. The method of claim 14, wherein the polyol mixture comprises at most six oils.

17. The method of claim 13, wherein the polyol mixture comprises a blend of one or more oils and at least one of a filler, air release additive, filler wetting aide, catalyst, color pigment, or rheology modifier.

18. The method of claim 13, further comprising removing said defect from said wood or wood product prior to the applying step.

19. The method of claim 18, wherein the removal of said defect is automated.

20. The method of claim 18, wherein the removal of said defect is manual.

21. The method of claim 13, wherein further comprising measuring the size and volume of the defect following identifying the location of said defect in said wood or wood product.

22. A method of building an article of furniture, comprising:
analyzing at least one piece of wood or wood product having a surface for a defect;
identifying defect in said at least one piece of wood or wood product;
identifying a location of said defect in the at least one piece of wood or wood product;
preparing for repair the surface of the at least one piece of wood or wood product in the location of the defect;
applying a two-component urethane to the surface of the at least one piece of wood or wood product of the article of furniture in the location of said defect, the two-component urethane comprising a polyol mixture and an isocyanate;
curing the two-component urethane for a period of time; and
building an article of furniture using said at least one piece of wood or wood product after the two-component urethane has cured for a period of time.
